(19) United States
(12) Patent Application Publication
(10) Pub. No.: US 2009/0047809 A1
(43) Pub. Date: Feb. 19, 2009

(54) Electrical connector having stiffener fastened by groups of one-step screw post and mating sleeve

(75) Inventor: Cheng-Chi Yeh, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/229,021

(22) Filed: Aug. 18, 2008

(30) Foreign Application Priority Data
Aug. 17, 2007 (CN) 200720042937.0

(51) Int. Cl. H01R 12/00

(52) U.S. Cl. 439/68

(57) ABSTRACT

One-step screws (30) and hollow mating limiters (40) are provided for fastening a stiffener (20) of a land grid array (LGA) socket connector (1) on a circuit board. The one-step screws having a shoulder portion (301) between a top portion (302) and the thread portion (303). Each of hollow mating limiters (40) has a lead-in surface (401) on a one end of inner surface of the limiter (40). Because the smallest diameter of the limiter (40) is substantially equal to the one of the shoulder portion (301), the one-step screws (30) are able to be effectively limited within a specific range so as to avoid the possibility of losing screws during moving socket connectors.

### BACKGROUND OF THE INVENTION

1. Field of the Invention

The present invention generally relates to an electrical connector, and more particularly to a plurality of fasteners for securely mounting a stiffener of the electrical connector on a circuit board, each of the stiffener fasteners includes a one-step screw post and a mating sleeve.

2. Description of Related Art

Integrated circuit packages are generally classified as pin grid array (PGA) packages, ball grid array (BGA) packages and land grid array (LGA) packages depending on the shape of contacting section of the terminals. An integrated circuit package with conductive pads arranged on a bottom surface thereof in a land grid array is known as an LGA package.

Connectors for removably connecting an LGA package with a PCB are known as LGA sockets. Basically, an LGA socket includes a socket body and a plurality of terminals embedded in the socket body. Each terminal has a contacting section and an opposite connecting section. Under compression, the contacting section of the terminal is resiliently deflected from its natural state and electrically registered with a conductive pad on the LGA package. Thus, a flow of electrical signals is established between the LGA package and the PCB.

U.S. Pat. No. 7,278,860 issued to Ma on Oct. 9, 2007 discloses a LGA socket connector. Refer to FIG. 1, the LGA socket connector 10 includes a insulative base 11 having a plurality of passageways 110 extending vertically therethrough for receiving a corresponding number of contacts 13 therein, a metallic stiffener 12 engaging with the housing 11, a metal clip 14 pivotally assembled to one end of the stiffener 12, a load lever 15 pivotally assembled to the stiffener 12, and a plurality of insulative supporting posts 16 attached to the stiffener.

Refer to FIG. 2, each the insulative supporting posts 16 can be further drilled a hole 163 for making screws 17 pass the stiffener 12 and the supporting posts such that the stiffener 12 is securely fixed on a circuit board 20 by screwing the screws 17 in apertures 200 of the circuit board 20. However, As shown in FIG. 3, such configuration easily loses the screws 17 before the LGA socket connector fixed on the circuit board. Therefore, it is needed to offer an improved electrical connector for avoiding lost of screws before fastening the LGA socket connector on the circuit board.

### BRIEF SUMMARY OF THE INVENTION

The invention has been developed in view of the circumstance illustrated above. An objective of the present invention is for providing a stiffener of an electrical connector with one-step screws and corresponding mating sleeves such that all screws are able to be limited in a specific range between the stiffener and a circuit board and effectively reduce the possibility of losing the screws due to the existence of the sleeves.

Another objective of the present invention provides a method of more securely fastening a stiffener of a electrical connector on a circuit board, comprising following steps at least: (a) providing the stiffener with a plurality of assemble holes; (b) providing a plurality of one-step screws passing through the assemble holes; (c) putting a plurality of mating sleeves around shoulder portions and thread portions of the one-step screws; and (d) screwing the one-step screws into a plurality of apertures of a circuit board for fastening the stiffener over the circuit board.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 illustrates an isometric view of a conventional LGA socket connector with support members underneath a stiffener;

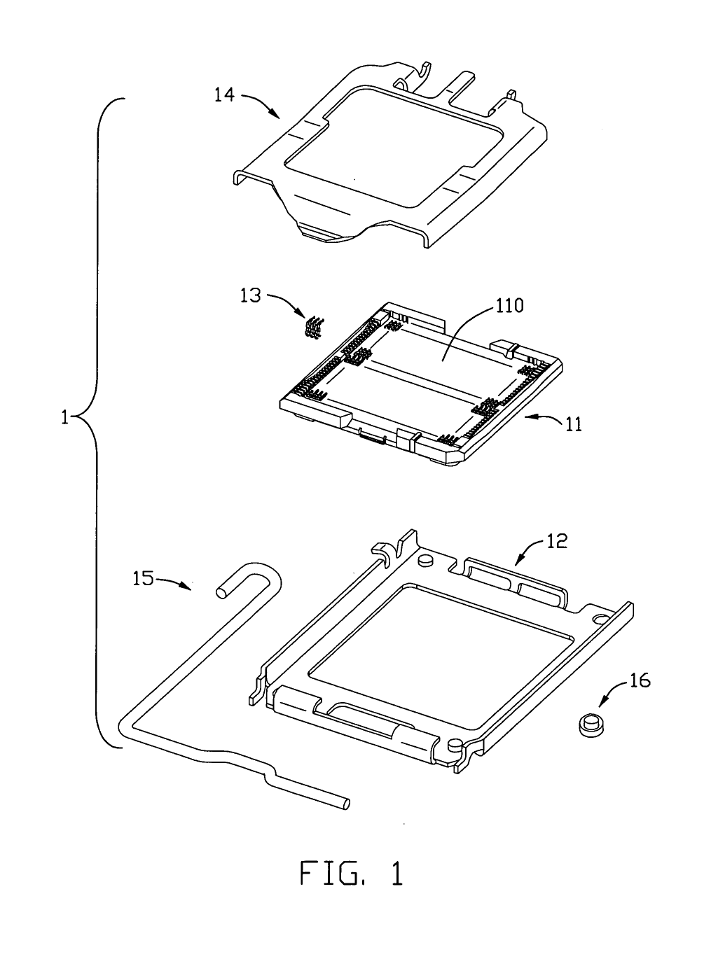

FIG. 2 illustrates an isometric view of the stiffener with support members shown in FIG. 1 fastening in a circuit board via screws;

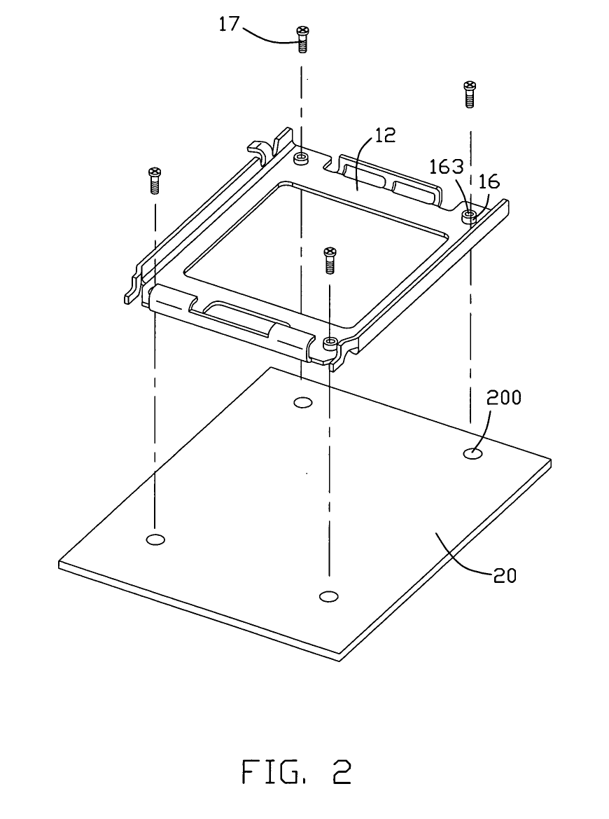

FIG. 3 illustrates a cross-sectional view of a screw and a supporting posting fastened both on a stiffener and a circuit board as shown in FIG. 2;

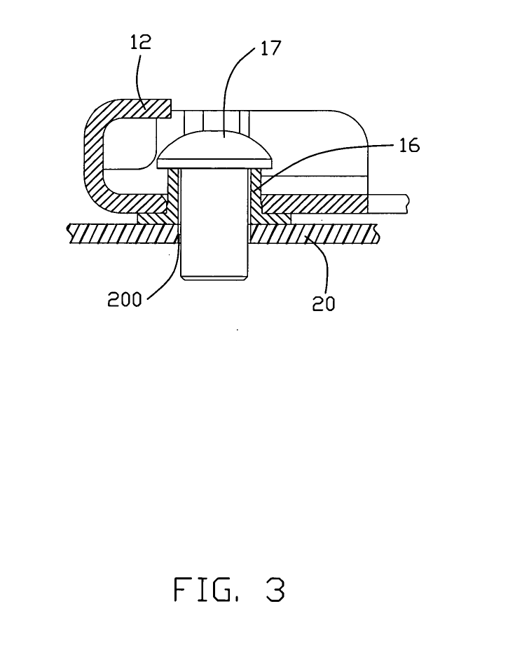

FIG. 4 illustrates an exploded view of a stiffener, an insulative housing, one-step screws and mating sleeves in accordance with the preferred embodiment of the present invention;

FIG. 5 illustrates a decomposed view of a one-step screw and a mating sleeve in accordance with the preferred embodiment of the present invention;

FIG. 6 illustrates an enlarged combination view of an assembled hole of a stiffener passed by a one-step screw mating with a mating sleeve in accordance with the preferred embodiment of the present invention; and

FIG. 7 illustrates a cross section view of a one-step screw and a mating sleeve fastened both on a stiffener and a circuit board in accordance with the preferred embodiment of the present invention.

### DETAILED DESCRIPTION OF THE INVENTION

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

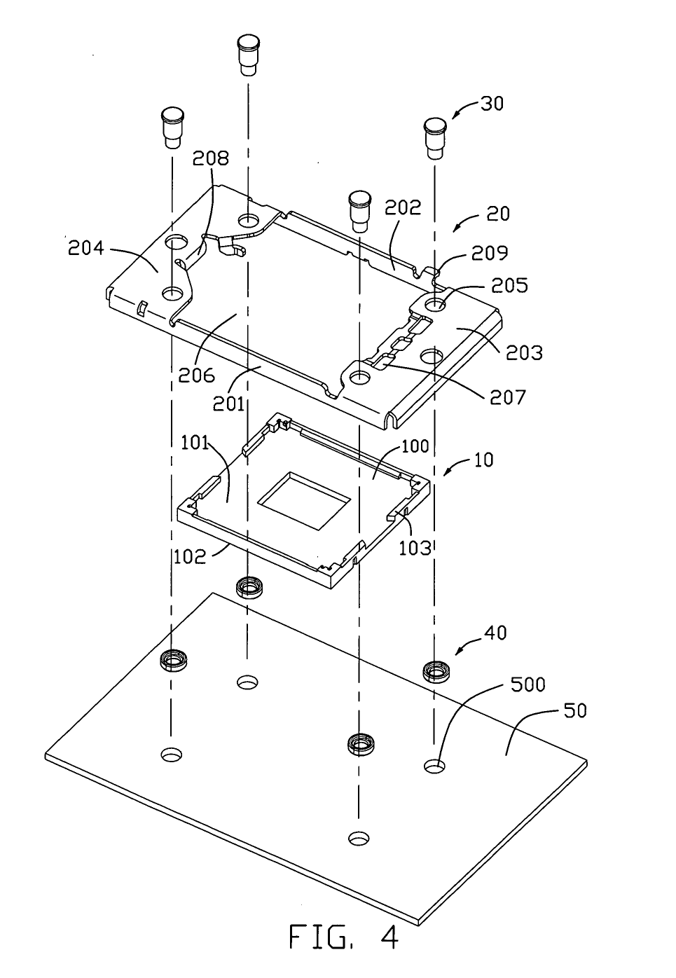

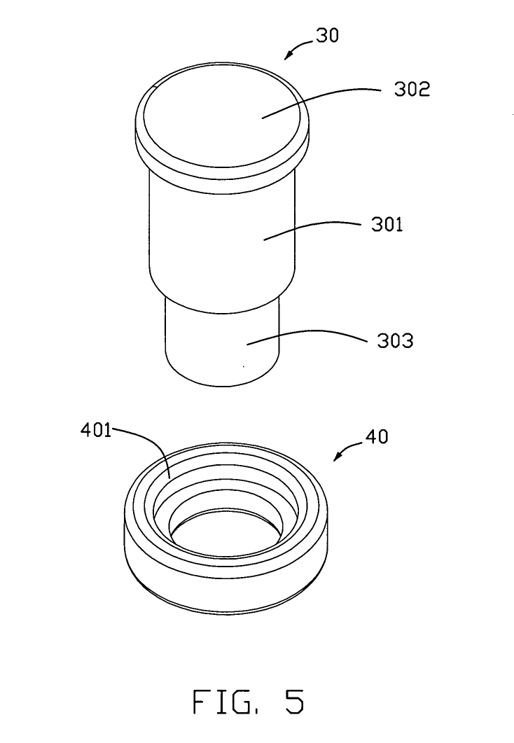

FIG. 4 illustrates an exploded view of an insulative housing 10, a stiffener 20, a plurality of one-step screws 30 and corresponding mating sleeves 40 for engaging with the screws 30 each other. It should be noted that the one-step screws 30 means each of the screws 30 has a shoulder portion 301 between the top portion 302 and the thread portion 303 as shown in FIG.5. In the preferred embodiment of the present invention, the inner cross section of the sleeve 40 is round. In addition, one end of an inner surface of the sleeve 40 has a lead-in surface 401 for receiving the thread portion 303 of the screws 30 more smoothly. In order to effectively limit the screws in a specific range and reduce the possibility of losing the screws 30 from the stiffener 20, the diameter of the shoulder is larger than the one of the thread portion 303 and smaller than the one of the top portion 301. Moreover, the diameter of the smallest inner surface of the sleeve 40 is substantially equal to the one of the thread portion 303.

Referring to FIG. 4 again, the stiffener 20 is made of metal and has a opening window 206 in the middle portion defined by a first lengthwise sidewall 201, a second lengthwise sidewall 202, a first end 203 and a second end 204. The opening window 206 is used for receiving the insulative housing 10. The insulative housing 10 comprises a base 100 and a plurality of sidewalls 103 to define a mounting surface 101 for receiving an integrated circuit package. The mounting surface 101 comprises a plurality of passageways in which a plurality of contact terminals constrains for electrically connecting the integrated circuit package. A rear side 102 of the mounting surface 101 is a soldering surface for mating the insulative housing with a circuit board. Furthermore, the stiffener 20 further comprises assemble holes 205 for being passed by the one-step screws 30, a plurality of assembled slot 207 in the first end 203 for pivotally attaching a load lever (not shown), a pivotal slot 208 in the second end 204 for pivotally attaching to a metal clip (not shown), and a latch portion 209 in the second lengthwise sidewall 202 for latching the load lever (not shown) while a metal clip is closed.

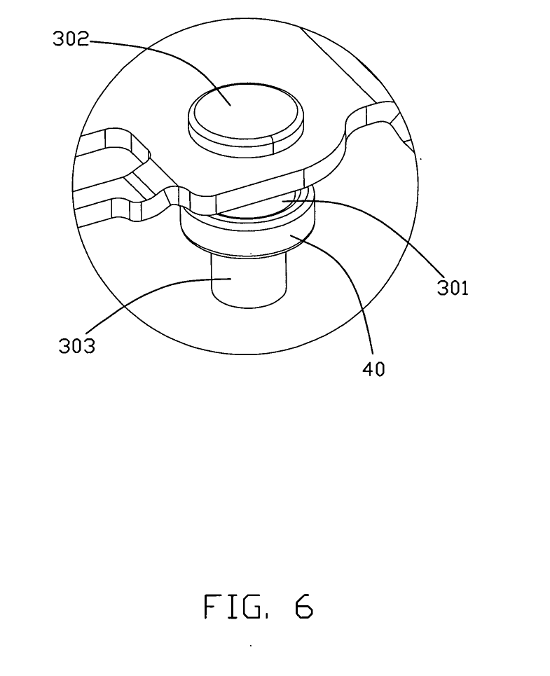

FIG. 6 illustrates an enlarged combination view of an assembled hole 205 of a stiffener 20 passed by a one-step screw 30 mating with a sleeve 40 in accordance with the preferred embodiment of the present invention. Because the inner cross section shape of the mating sleeve 40 is round and the smallest diameter of the inner surface of the sleeve 40 is substantially equal to the one of the thread portion 303, the sleeve 40 is able to securely attach both on the shoulder portion 301 and the thread portion 303 of the one-step screw 30 via a interfering force between the sleeve 40 and the thread portion 303.

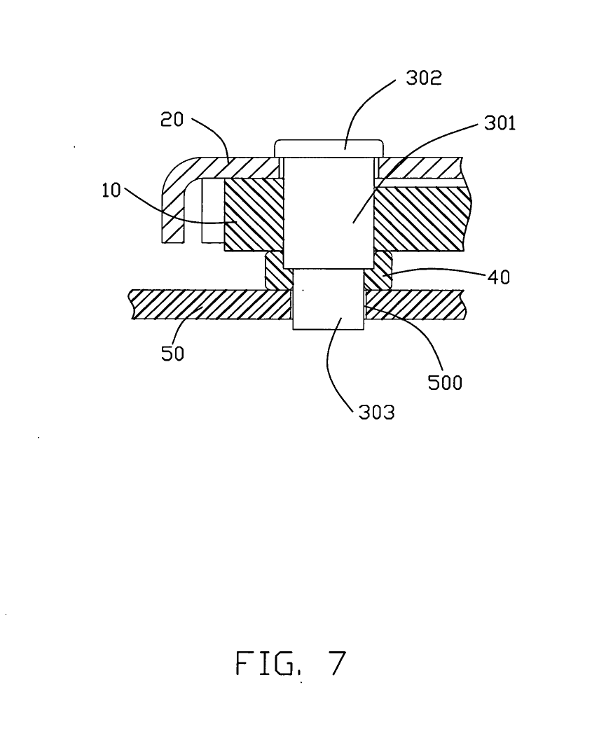

FIG. 7 is a cross section view of a one-step screw 30 and a mating sleeve 40 fastened both on a stiffener and a circuit board. The existence of the mating sleeve 40 both mating on the shoulder portion 301 and the thread portion 303 of the one-step screw 30 is effectively restricted to the moving of the one-step screw 30 as soon as the one-step screw 30 is fastened on a hole 500 of a circuit board 50 through an assemble hole 205 of a stiffener 20. Therefore, such configuration is able to be limited the one-step screws in a specific range between the stiffener and the circuit board and effectively reduce the possibility of losing the screws.

Although the present invention has been illustrated and described with respect to exemplary embodiment thereof, it should be understood by those skilled in the art that the various changes, omissions and additions may be made therein and thereto without departing from the spirit and scope of the present invention as set forth in the appended claims.

What is claimed is:

1. An LGA socket connector, comprising:
an insulative base having an inner cavity with a plurality of passageways in which a plurality of contact terminals are constrained;
a stiffener engaging with the base having a plurality of openings for receiving a plurality of one-step screws,
a metal clip pivotally assembled to a first end of the stiffener;
a load lever pivotally assembled to a second end of the stiffener; and
a plurality of hollow mating limiters correspondingly attached to both of a shoulder portion in the middle and a thread portion in one end of a one-step screws.

2. The LGA socket connector as claimed in claim 1, wherein the other end of the one-step screw is a top portion.

3. The LGA socket connector as claimed in claim 2, wherein the diameter of the top portion is larger than the one of the shoulder portion, the diameter of the shoulder portion is larger than the one of thread portion.

4. The LGA socket connector as claimed in claim 3, wherein the inner diameter of the limiter is substantially equal to the one of the shoulder portion of the one-step screw.

5. The LGA socket connector as claimed in claim 1, wherein the limiter is made of insulative material.

6. The LGA socket connector as claimed in claim 1, wherein an inner surface of the limiter further comprises a lead-in surface for receiving the one-step screw more smoothly.

7. The LGA socket connector as claimed in claim 1, wherein there is a gap between the stiffener and the limiter.

8. The LGA socket connector as claimed in claim 1, wherein the shape of the limiter is annular.

9. A method of fastening a stiffener of a socket connector on a circuit board, comprising the steps of:
(a) providing the stiffener with a plurality of assemble holes;
(b) providing a plurality of one-step screws passing through the assemble holes;
(c) putting a plurality of hollow mating limiters around shoulder portions in the middle and thread portions in one end of the one-step screws; and
(d) screwing the one-step screws into a plurality of apertures of a circuit board for fastening the stiffener over the circuit board.

10. The method as claimed in claim 9, wherein the other end of the one-step screw is a top portion.

11. The method as claimed in claim 10, wherein the diameter of the top portion is larger than the one of the shoulder portion, the diameter of the shoulder portion is larger than the one of thread portion.

12. The method as claimed in claim 11, the inner diameter of the limiter is substantially equal to the one of the shoulder portion of the one-step screw.

13. The method as claimed in claim 9, wherein the limiter is made of insulative material.

14. The method as claimed in claim 9, wherein an inner surface of the limiter further comprises a lead-in surface for receiving the one-step screw more smoothly.

15. The method as claimed in claim 9, wherein there is a gap between the stiffener and the limiter.

16. The method as claimed in claim 9, wherein the shape of the limiter is annular.

17. An electrical connector assembly comprising:
a printed circuit board;
an insulative housing positioned upon the printed circuit board via a mating sleeve therebetween, said mating sleeve defining a shoulder structure therein;
a metallic stiffener positioned upon housing; and
a screw extending through the stiffener, the housing, the mating sleeve and the printed circuit board under a condition that the screw defines a head seated upon the stiffener, and a step structure seated upon the shoulder structure so as to have the stiffener, the housing, the mating sleeve and the printed circuit board stacked upon one another tightly.
